(19) United States
(12) Patent Application Publication
(10) Pub. No.: US 2010/0037204 A1
(43) Pub. Date: Feb. 11, 2010

(54) Content Distribution for Mobile Device

(75) Inventors: Jennifer W. Lin, Mountain View, CA (US); Kuan-Loong Yong, San Francisco, CA (US); Ravi Jain, Palo Alto, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/187,992

(22) Filed: Aug. 7, 2008

(51) Int. Cl. G06F 9/44

(52) U.S. Cl. 717/106

(57) ABSTRACT

Among other disclosed subject matter, a computer-implemented method for providing content distribution for a mobile device includes providing a software development kit to a developer for developing an application for a mobile device. The software development kit includes an object to be inserted into the application and configured for requesting content for the application. The method includes identifying a context parameter regarding the application for use in selecting content to be distributed to the application on the mobile device. The method includes forwarding the content to the mobile device, the content being selected using the context parameter and configured to be presented to a user of the mobile device.

### TECHNICAL FIELD

This document relates to information processing.

### BACKGROUND

Advertising in online mediums have some similarities with traditional print-based advertising. For example, it is usually desirable to target the advertisement to the intended or expected audience, because advertisers generally prefer to invest in advertising if it reaches many potential customers, as opposed to persons who have little or no interest in the product or service being advertised. In print media, this targeting could be based on the general knowledge about who the readers are, or market investigations can be performed on the readers to more accurately determine their interests.

In the online environment, the users likewise have particular interests and disinterests, and publishers sometimes try to match the advertisement displayed on a page to the particular viewer as well as possible. However, much of the information required to understand who the viewers are may not be known or readily available and thus the advertisement targeting may be based on little or no relevant information.

### SUMMARY

The invention relates to content distribution for a mobile device.

In a first aspect, a computer-implemented method for providing content distribution for a mobile device includes providing a software development kit to a developer for developing an application for a mobile device. The software development kit includes an object to be inserted into the application and configured for requesting content for the application. The method includes identifying a context parameter regarding the application for use in selecting content to be distributed to the application on the mobile device. The method includes forwarding the content to the mobile device, the content being selected using the context parameter and configured to be presented to a user of the mobile device.

Implementations can include any, all or none of the following features. The method can further include providing an application program interface configured to be used by the object in requesting the content, the object configured to construct a content request based on customization by the developer, receive the content and provide for presentation of the content on the mobile device. Identifying the context parameter can include receiving the application from the developer; and extracting the context parameter from content of the application. The method can further include receiving a new version of the application from the developer at a later time; and revising the context parameter using the new version of the application. Identifying the context parameter can include receiving the context parameter from the developer, and recording the content parameter in association with the object. Forwarding the content can include determining what page of a plurality of pages is currently active in the application; and selecting the content at least in part based on the page. Determining what page is currently active in the application can include receiving an identifier forwarded by the object, the identifier indicating the page. The identifier can be obtained in the application using a global variable that is updated in execution of the application. Forwarding the content can include pre-fetching the content; forwarding the content to the mobile device, the content configured to be stored on the mobile device for presentation at a later time; and receiving confirmation from the mobile device that the content has been presented.

In a second aspect, a system includes a first system available to a developer and including: (1) a program development platform for the developer to create an application configured for a mobile device, and (2) an object configured to be inserted into the application by the developer, to generate a request for content for the application based on a context parameter, and to present the content to a user of the mobile device. The system includes a second system configured to receive the request from the first system, select the content based on the context parameter, and forward the content to the mobile device.

Implementations can include any, all or none of the following features. The first system can further include a software development kit for providing content distribution, the software development kit comprising at least the program development platform and the object. The first system can further include an application program interface configured to be used by the object in requesting the content, the object configured to construct a content request based on customization by the developer, receive the content and provide for presentation of the content on the mobile device. The first system can further be configured to forward the application to the second system for extracting the context parameter from content of the application. The first system can further be configured to forward a new version of the application to the second system at a later time for revising the context parameter using the new version of the application. The first system can further be configured to forward the context parameter to the second system for recording the content parameter in association with the object. The object can be configured to determine what page of a plurality of pages is currently active in the application and forward an identifier of the page to the second system, and the second system can select the content at least in part based on the page. The object can be configured to obtain the identifier in the application using a global variable that is updated in execution of the application. Content can be pre-fetched and stored on the mobile device for presentation at a later time, and the object can be configured to forward a confirmation from the mobile device that the content has been presented. The object can be configured to track an interaction of the user with the content on the mobile device.

In a third aspect, a computer-implemented method for providing content distribution for a mobile device includes generating an application for a mobile device using a software development kit. The method includes adding a preconfigured object to the application before compilation, the object obtained from the software development kit and configured for requesting content for the application. The method includes providing a context parameter associated with the application to a content distributor, the context parameter configured for use by the content distributor in selecting the content for forwarding to the mobile device.

Implementations can include any, all or none of the following features. Providing the context parameter can include forwarding the application to the content distributor.

In a fourth aspect, a computer-implemented method for providing content distribution for a mobile device includes generating an application for a mobile device using a software development kit, the application including a preconfigured object configured for requesting content for the application. The method includes providing the application to the mobile device, wherein the object requests the content from a content provider during use of the mobile device, the content distributor using a context parameter in selecting the content. The method includes receiving from the mobile device information obtained by tracking an interaction of a user with the content on the mobile device.

In a fifth aspect, a computer-implemented method for providing content distribution for a mobile device includes providing an object to be inserted into a mobile device application and configured for requesting content for the application. The method includes identifying a context parameter regarding the application. The method includes selecting content to be distributed to the application on the mobile device using the context parameter. The method includes forwarding the content to be presented to a user of the mobile device.

Implementations can include the feature that the content is selected at a server device that is remotely connected to the mobile device, and the server device can receive a request for the content and the content is forwarded from the server device to the mobile device.

In a sixth aspect, a system includes a server device configured to identify content based on a context parameter. The system includes a developer system available to a developer, the developer system including a program development platform for the developer to create an application, and an object for the developer to include in the application program. The system includes a mobile device to execute the application created at the developer system, request the content from the server device using the object, and present the content to a user.

Implementations can include the feature that the developer system includes a software development kit that is used in creating the application, the software development kit including the object and conforming with the program development platform.

Implementations can provide any, all or none of the following advantages. Content distribution for a mobile device can be improved. A convenient way for a publisher to add content presentation features to a mobile device application can be provided. An object can be provided in a software development kit that can be inserted in application code before compiling to provide for fetching, presentation and tracking of content such as advertisements on a mobile device.

The details of one or more embodiments are set forth in the accompanying drawings and the description below. Other features and advantages will be apparent from the description and drawings, and from the claims.

### DESCRIPTION OF DRAWINGS

FIG. 1 shows an example of a system including an application for a mobile device.

FIGS. 2-3 are flowcharts of example methods.

FIG. 4 shows an example UML diagram.

FIG. 5 is a block diagram of a computing system that can be used in connection with computer-implemented methods described in this document.

Like reference symbols in the various drawings indicate like elements.

### DETAILED DESCRIPTION

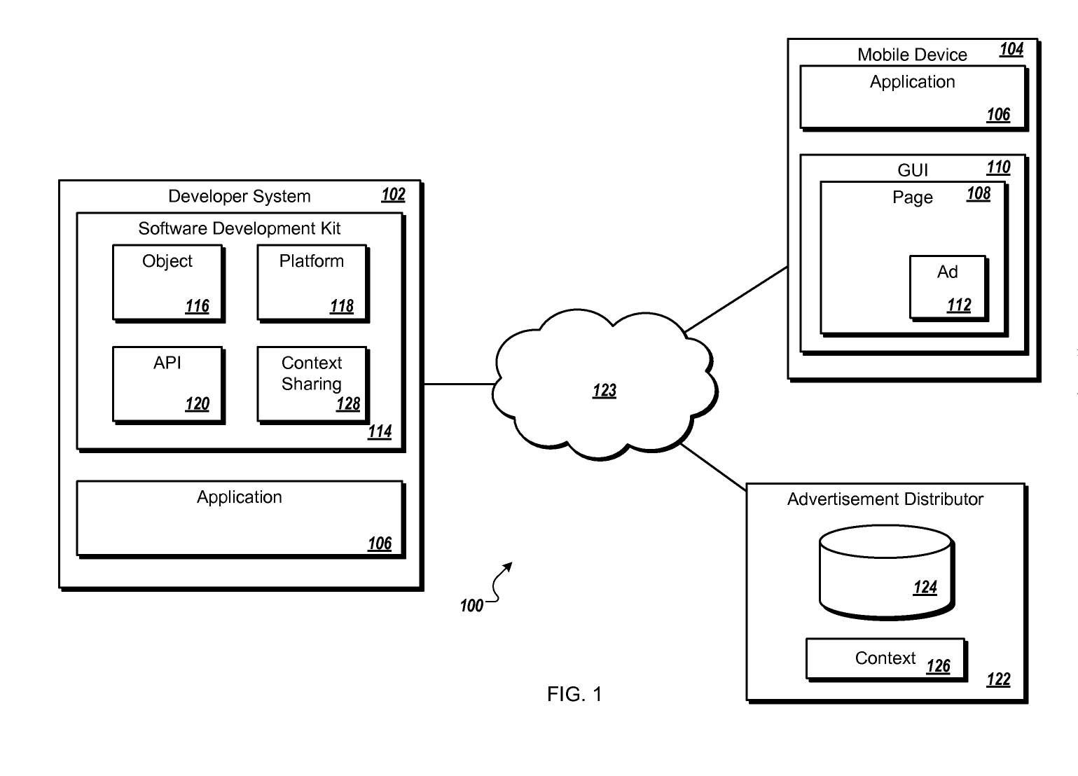

FIG. 1 shows an example of a system 100 including an application for a mobile device. In this example, a developer system 102 can be used by a developer to create program content such as applications for one or more mobile devices 104, such as a cellular telephone, a personal digital assistant or any other type of mobile device. Particularly, the developer can create an application 106 such as by generating program code and compiling it into an executable program compatible with the mobile device 104. The application 106 can be formulated so that it presents one or more pages 108 in a graphical user interface 110 of the mobile device 104, such as on a display screen. Individual systems and/or components can be implemented using hardware, firmware, software, or combinations thereof, and can be divided or joined into different number of units. Examples below will illustrate how the developer can configure the application 106 so that content 112, such as an advertisement from a third party, can be presented on the page(s) 108 when the application 106 is being executed.

A software development kit 114 can be provided to the developer for creating the application 106 and/or other programs. The software development kit 114 can provide editors for code and/or pseudocode, one or more compiling functions, emulating functions for previewing display content, and a debugging function, to name just a few examples. In some implementations, the software development kit 114 can also be configured to provide the developer a convenient way of adding third-party content such as advertisements to a program created for mobile devices. For example, the software development kit 114 can provide the developer with the necessary code and/or other application content so that advertisements are requested, displayed to a user, and that any interaction between the user and the ad is tracked.

The software development kit 114 can provide one or more objects 116. In some implementations, the developer can incorporate the object 116 in the code when creating the application. For example, the software development kit 114 can provide the object(s) 116 on a screen, such as where the developer generates the overall application content, in a way that the developer can select the object and include the corresponding material in the application as it is being created.

The software development kit can be configured so that the application(s) 106 can be created according to a particular platform 118. In some implementations, the platform 118 can be targeted to mobile devices, such as to the type of the mobile device 104 which can include a cell phone, handheld device, personal digital assistant, to name just a few examples. For example, the platform 118 can be a platform created or supported by the Open Handset Alliance. In some implementations, the object 116 is included before the application code is compiled into an executable program. For example, the object can be incorporated as an integrated part of the application by inserting code before compilation.

The object 116 can perform one or more functions. In some implementations, the object can cause third party content such as the advertisement(s) 112, to appear on the mobile device 104. For example, the object 116 can be responsible for requesting relevant ad(s), displaying the ad(s) in the right manner to the user, and tracking whether the user clicks on the ad or otherwise interacts with the ad.

In some implementations, the object 116 is a Java object that is configured to be added to a user interface of the application 106 and handle fetching and rendering of, and interaction with, content such as advertisements. For example, the developer can implement a view object that extends a view class associated with the application 106. In some implementations, an advertising view object could include the following:

GoogleBaseAdView(String client)

This can represent a base class to create an advertisement view. A constructor can set the client parameter in a content ads request that can include a URL for a frontend involved in content requests. The above object can extend a more general view class, such as a WebView class used in some implementations from Google Inc. and can in some implementations be extended by other more specific classes directed at advertising. In some examples, such an extension can use

void setAdLayoutType(int placement)

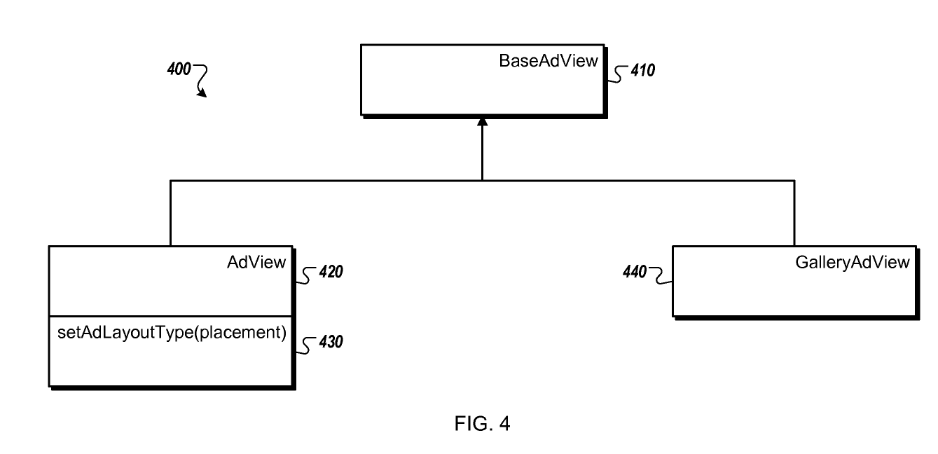

to specify top and/or bottom placement of the view that requests the content. Other ways of displaying the content (e.g., an advertisement) can be used, such as a gallery that places thumbnails of image content in a gallery view. Further examples are described below with reference to FIG. 4.

One or more functions can be used with the object. Such function(s) can customize the look and feel of the content when it is displayed. In some implementations, such function(s) can set one or more CGI parameters in a. For example, any or all of the following functions can be used:

void setAdType(String adType)

void setChannels(String[ ] channels)

void setBackgroundColor(Color color)

void setBorderColor(Color color)

void setTitleColor(Color color)

void setTextColor(Color color)

void setUrlColor(Color color)

void setScreenContent(String content)

void setFormat(String format)

void setCity(String city)

void setCountryString country)

void setRegion(String region)

void setLanguage(String languagecode)

void setlp(String ip)

void setKeywords(String[ ] keywords)

void setOutputEncoding(String encoding)

void setScreenWidth(int width)

void setScreenHeight(int height)

void setUserAgent(String userAgent)

An application program interface (API) 120 can be used with the object 116. In some implementations, the API is a Java API that a developer can call when incorporating content such as advertisements into the application 106. For example, the object 116 can include a Java code snippet that uses the Java API 120 so that the developer can insert the code into the application 106. As noted earlier, such a code snippet can construct a request for content such as an ad based on a developer's customization, fetch the content and write it to the user interface of the application 106.

The ad 112 can include any kind of content. In some implementations, ad types including, but not limited to, text ads, image ads (such as animated GIFs and/or Flash-based images) and video ads can be used. For example, the ad can provide for user navigation (e.g., a link) to other content associated with the advertiser. Other types of content are possible (e.g., non-advertising content).

An advertisement distributor system 122 can be used to forward any type of content such as the ad 112 to the mobile device 104 and/or the developer system 102. In some implementations, the advertisement distributor system 122 is configured to receive request(s) for content from the mobile device 104, fetch one or more matching ads or other content from a repository 124, and forward the matching content to the mobile device. For example, the matching of the ad 112 can be performed using a context component 126, which can provide one or more context parameters associated with the application 106 configured for identifying matching content/advertisements.

The developer system 102, the mobile device 104 and/or the advertisement distributor system 122 can be connected using any kind of network 123, such as the Internet. For example, the developer system 102 and the advertisement distributor system 122 can communicate using the TCP/IP suite of protocols and the mobile device 104 can communicate using any kind of wireless protocol, such as IEEE 802.11, WAP and/or Bluetooth.

Relevant context of the application 106 and/or the mobile device 104 can be shared in different ways. In some implementations, the developer can share context including metadata about the application 106 with the advertisement distributor system 122. A context sharing component 128 in the software development kit 114 can allow the developer to enter one or more keywords that the developer decides are relevant for retrieving and presenting content such as advertisements. For example, the developer who creates the application can submit the keyword(s) using the context sharing component 128 for receipt by the context component 126 for storage. In some implementations, monitoring can be performed to determine how well the submitted metadata correlates with the application 106 and if necessary, modifications in the used context parameter(s) can be made.

In some implementations, context can be shared by the developer submitting the application 106 to the advertisement distributor system 122. The context sharing component 128 can be used in submitting some or all of the application 106 for use in evaluating context. This can be done as part of a setup process so that the advertisement distributor system 122 can examine the application to determine the context of the content/ads to be forwarded. Examples of aspects that can be taken into account include, but are not limited to, textual content of a previous screen or page on the mobile device 104, a content of the entire application 106, and/or content of other view objects such as sibling objects. Analysis of the application 106 can include analyzing the code (such as by static analysis), determining a general context of the application 106, or determining the specific context of one or more of the particular pages 108. This can require the context component 126 to determine which of the pages 108 is currently active in the mobile device 104. For example, this can be done using a version of the application 106 provided by the developer. If or when the application 106 is later updated, a revised version can be forwarded to the advertisement distributor system 122, for example using the context sharing component 128, so that the context can be updated if necessary.

As another example, context can be determined by providing that the developer can specify one or more hooks in the code of the application 106. In some implementations, the software development kit 114 and/or the platform 118 can provide such feature(s). For example, a global variable can be made to change state at one or more stages of the application 106. Such a variable can be read by the object 116, such as by a snippet of Java code.

Context parameter(s) for use in finding matching content such as advertisements can be stored in any of a variety of forms. For example, the context component 126 can store one or more keywords, categories, labels, topics, context information and/or any other kind of parameter for use by the advertisement distributor system 122.

The following is an example of how an implementation as described above can be used. A developer can create the application 106 intended for the mobile device 104 using the software development kit 114. Particularly, the application 106 can be created according to the platform 118 and can include the object 116. The developer can forward the application 106 to the mobile device for use, for example when the device 104 is initially sold or as a later update, such as by a download process. The developer can also provide context relating to the application 106, such as by submitting one or more keywords and/or providing a version of the application 106, using the context sharing component 128. One or more context parameters can be registered at the advertisement distribution system 122.

When a user operates the mobile device 104, content such as one or more ads 112 can be presented on the page(s) 108. The content can be selected for presentation by the advertisement distribution system 122 based on the context parameter(s). In some implementations, the user can interact with the ad(s) 112 in one or more ways, such as by clicking on the ad 112, performing a developer-specified combination of key presses (e.g., tapping a single key twice, or tapping two keys in rapid succession), or tapping on the ad on a touchscreen device.

The selection of content such as an advertisement can be performed using a location of the mobile device 104. In some implementations, the developer can provide an opportunity for the user of the mobile device 104 to opt in so that the user's location can be used in targeting content for the mobile device 104. If the user consents, the application 106 and/or the object 116 can provide that the user's location is sent in connection with the request forwarded to the advertisement distribution system 122. For example, the mobile device 104 can have an API for determining location, such as using GPS and/or wi-fi signals, and based on this the API 120, which can be Java-based, can use logic to retrieve the location of the mobile device 104. In some examples, such location information can constitute or be part of the context that is taken into account.

Content such as advertisements can be retrieved in any of a variety of ways. In some implementations, content can be retrieved essentially according to an on-demand approach. For example, ads or other content can be requested from the advertisement distribution system 122 and forwarded from there for display virtually immediately. Such implementations can have the advantage that the ad that is displayed to the user can be very current to the particular state of the application 106 and/or the mobile device 104.

In some implementations, a pre-fetch approach can be used. For example, a developer can configure the application 106 such that multiple content portions such as ads are requested from the advertisement distribution system 122. The ads can be stored at a suitable location, such as on the mobile device 104 and/or on another computer device such as a server that communicates with the mobile device 104. At some point, such as by determination performed by the application 106, the ad(s) can be displayed on the mobile device 104, for example when it returns to an online mode after having been offline. The developer can provide for reporting of which contents/ads have been displayed, for example by incorporating a feature from the software development kit 114 into the application 106. In some implementations, client-side frequency capping can be used, for example by having a class associated with content/ad presentation track previously served content/ads and ensure that the same content/ad is presented according to a rule (e.g., not more than a predetermined number of times per session). Other approaches for fetching content can be used.

In some implementations, a new content portion such as the ad 112 can be presented when an activity that uses the class associated with content/ad presentation is displayed for the first time. As another example, the new ad/content can be presented when the activity has been removed from an activity stack in the mobile device 104. In yet another example, a content/ad can be presented if a previous ad/content has been displayed for a predetermined amount of time if the mobile device 104 continues to be active (e.g., if a backlight of the display on the device remains on). In some implementations, the developer can facilitate user-initiated refresh of content/ads via a class responsible for generating gallery views, for example to provide a carousel-style browsing of ads.

The software development kit 114 has been mentioned in examples above. In some implementations, the kit 114 can be extended or enhanced using a wizard in an interface directed toward publishers. For example, the advertisement distributor system 122 can provide a user interface where publishers can establish an account to become affiliated with an advertising program, and this interface can feature the wizard as a way for the developer(s) to customize the look and feel of content/ads to be displayed in connection with the application 106. In some implementations, this can be implemented as a self-service sign-up process for developers, for example to allow the opportunity to enhance their application offering with ads and/or other content. As another example, and assuming that users' privacy rights are taken into account, such an interface can provide reporting statistics on ad clicks, impressions, queries, revenue and/or other aspects to the advertisement distributor system 122.

In some implementations, a user can opt out of the opportunity to have ads or other content forwarded to the mobile device 104. For example, this can be done of a per-use basis or as part of some other policy decided by the developer. In some examples, the platform 118 can provide a “show ads” preference that can be maintained by the user. Before a mobile request for an ad or other content is constructed, this preference can be checked, for example using the API 120.

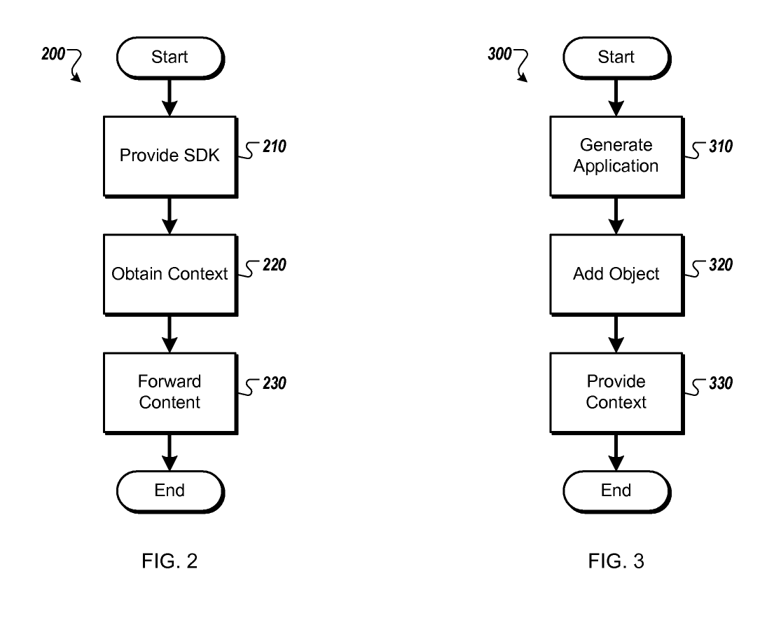

FIGS. 2 and 3 are flowcharts of example methods 200 and 300. In some implementations, the method 200 and/or 300 can be performed by a processor executing instructions in a computer-readable storage medium. For example, the method 200 and/or 300 can be performed in the system 100. More or fewer steps can be performed; as another example, one or more steps can be performed in a different order.

Step 210 of method 200 involves providing a software development kit to a developer for developing an application for a mobile device. The software development kit includes an object to be inserted into the application and configured for requesting content for the application. For example, the software development kit 114 can be provided to the developer system 102, such as from the advertisement distributor system 122. The software development kit 114 can include the object 116 that can be inserted into the application 106 before compiling and that can request the ad 112.

Step 220 involves obtaining a context parameter regarding the application for use in selecting content to be distributed to the application on the mobile device. For example, the context sharing component 128 can interact with the context component 126 to provide a context for use in matching ads or other content with the mobile device 104.

Step 230 involves forwarding the content to the mobile device, the content being selected using the context parameter and configured to be presented to a user of the mobile device. For example, the advertisement distributor system 122 can forward the ad 112 to the mobile device 104.

Turning now to method 300, step 310 involves generating an application for a mobile device using a software development kit. For example, a developer can generate the application 106 for the mobile device 104 using the software development kit 114.

Step 320 involves adding a preconfigured object to the application before compilation, the object obtained from the software development kit and configured for requesting content for the application. For example, the developer can add the object 116 to the code of the application 106 before compilation.

Step 330 involves providing a context parameter associated with the application to a content distributor, the context parameter configured for use by the content distributor in selecting the content for forwarding to the mobile device.

FIG. 4 shows an example UML diagram 400. For example, the diagram 400 can graphically represent relationships between classes that can be used in some implementations, such as in the system 100. Here, the diagram includes a BaseAdView class 410. In some examples, the class 410 can serve as a base class for creating a content view, such as a view of advertising content. For example, the class 410 can contain functionality for constructing a request for content such as ads, fetch the content and display the content. In some implementations, the class 410 can extend a more general class, such as a class directed at generating views of web content.

The class 410 can be extended in one or more ways. Here, the class 410 is extended by an AdView class 420, for example to specify one or more different types of content layouts, such as where on a screen the content is to be presented (e.g., at a top or a bottom). In some implementations, a function 430 can be defined for the class 420. Here, the function 430 is named “setAdLayoutTypeo” and uses one or more arguments, such as a “placement” variable. Other functions and/or arguments can be used.

Here, the class 410 is extended by a GalleryAdView class 440. In some implementations, the class 440 can provide that content such as ads is displayed in one or more particular ways. For example, the class 440 can enhance the BaseAdView class 410 such that the content can be displayed in a carousel style format on a display device.

More or fewer extensions of the class 410 can be used.

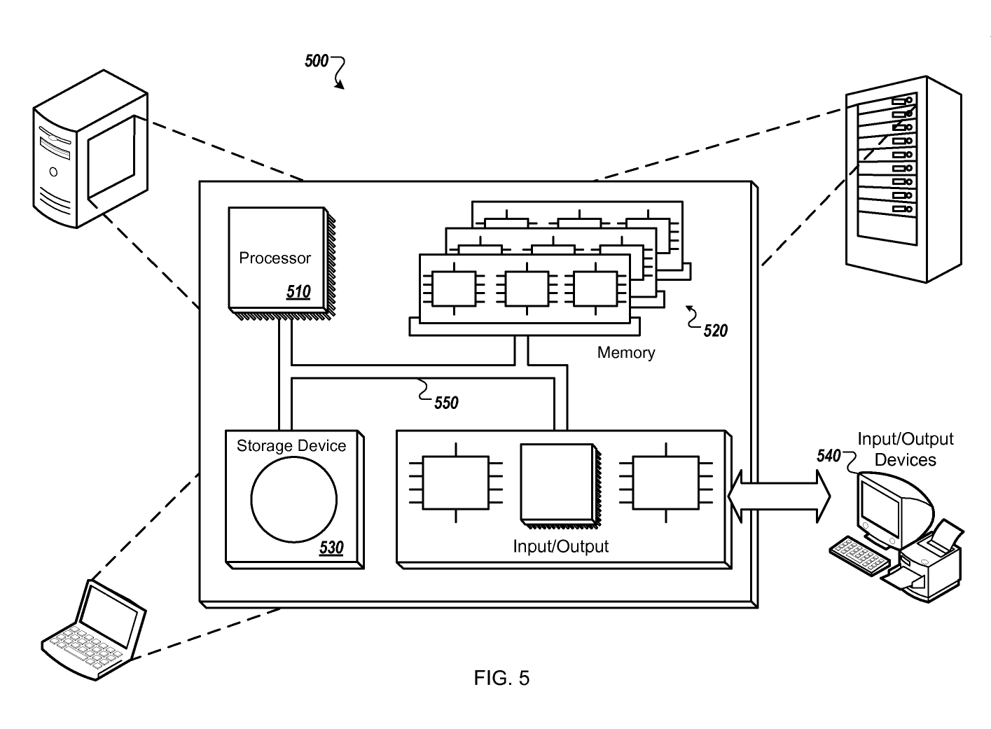

FIG. 5 is a schematic diagram of a generic computer system 500. The system 500 can be used for the operations described in association with any of the computer-implement methods described previously, according to one implementation. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A computer-implemented method for providing content distribution for a mobile device, the method comprising:
providing a software development kit to a developer for developing an application for a mobile device, the software development kit comprising an object to be inserted into the application and configured for requesting content for the application;
identifying a context parameter regarding the application for use in selecting content to be distributed to the application on the mobile device; and
forwarding the content to the mobile device, the content being selected using the context parameter and configured to be presented to a user of the mobile device.

2. The computer-implemented method of claim 1, further comprising:
providing an application program interface configured to be used by the object in requesting the content, the object configured to construct a content request based on customization by the developer, receive the content and provide for presentation of the content on the mobile device.

3. The computer-implemented method of claim 1, wherein identifying the context parameter comprises:
receiving the application from the developer; and
extracting the context parameter from content of the application.

4. The computer-implemented method of claim 3, further comprising:
receiving a new version of the application from the developer at a later time; and
revising the context parameter using the new version of the application.

5. The computer-implemented method of claim 1, wherein identifying the context parameter comprises:
receiving the context parameter from the developer, and recording the content parameter in association with the object.

6. The computer-implemented method of claim 1, wherein forwarding the content comprises:
determining what page of a plurality of pages is currently active in the application; and
selecting the content at least in part based on the page.

7. The computer-implemented method of claim 6, wherein determining what page is currently active in the application comprises:
receiving an identifier forwarded by the object, the identifier indicating the page.

8. The computer-implemented method of claim 7, wherein the identifier is obtained in the application using a global variable that is updated in execution of the application.

9. The computer-implemented method of claim 1, wherein forwarding the content comprises:
pre-fetching the content;
forwarding the content to the mobile device, the content configured to be stored on the mobile device for presentation at a later time; and
receiving confirmation from the mobile device that the content has been presented.

10. A system comprising:
a first system available to a developer and including: (1) a program development platform for the developer to create an application configured for a mobile device, and (2) an object configured to be inserted into the application by the developer, to generate a request for content for the application based on a context parameter, and to present the content to a user of the mobile device; and
a second system configured to receive the request from the first system, select the content based on the context parameter, and forward the content to the mobile device.

11. The system of claim 10, wherein the first system further comprises:
a software development kit for providing content distribution, the software development kit comprising at least the program development platform and the object.

12. The system of claim 10, wherein the first system further comprises:
an application program interface configured to be used by the object in requesting the content, the object configured to construct a content request based on customization by the developer, receive the content and provide for presentation of the content on the mobile device.

13. The system of claim 10, wherein the first system is further configured to forward the application to the second system for extracting the context parameter from content of the application.

14. The system of claim 13, wherein the first system is further configured to forward a new version of the application to the second system at a later time for revising the context parameter using the new version of the application.

15. The system of claim 11, wherein the first system is further configured to forward the context parameter to the second system for recording the content parameter in association with the object.

16. The system of claim 10, wherein the object is configured to determine what page of a plurality of pages is currently active in the application and forward an identifier of the page to the second system, wherein the second system selects the content at least in part based on the page.

17. The system of claim 16, wherein the object is configured to obtain the identifier in the application using a global variable that is updated in execution of the application.

18. The system of claim 16, wherein content is pre-fetched and stored on the mobile device for presentation at a later time, and wherein the object is configured to forward a confirmation from the mobile device that the content has been presented.

19. The system of claim 10, wherein the object is configured to track an interaction of the user with the content on the mobile device.

20. A computer-implemented method for providing content distribution for a mobile device, the method comprising:
generating an application for a mobile device using a software development kit;
adding a preconfigured object to the application before compilation, the object obtained from the software development kit and configured for requesting content for the application; and
providing a context parameter associated with the application to a content distributor, the context parameter configured for use by the content distributor in selecting the content for forwarding to the mobile device.

21. The method of claim 20, wherein providing the context parameter comprises:
forwarding the application to the content distributor.

22. A computer-implemented method for providing content distribution for a mobile device, the method comprising:
generating an application for a mobile device using a software development kit, the application including a preconfigured object configured for requesting content for the application;
providing the application to the mobile device, wherein the object requests the content from a content provider during use of the mobile device, the content distributor using a context parameter in selecting the content; and
receiving from the mobile device information obtained by tracking an interaction of a user with the content on the mobile device.

23. A computer-implemented method for providing content distribution for a mobile device, the method comprising:
providing an object to be inserted into a mobile device application and configured for requesting content for the application;
identifying a context parameter regarding the application;
selecting content to be distributed to the application on the mobile device using the context parameter; and
forwarding the content to be presented to a user of the mobile device.

24. The method of claim 23, wherein the content is selected at a server device that is remotely connected to the mobile device, wherein the server device receives a request for the content and the content is forwarded from the server device to the mobile device.

25. A system comprising:
a server device configured to identify content based on a context parameter;
a developer system available to a developer, the developer system including a program development platform for the developer to create an application, and an object for the developer to include in the application program; and
a mobile device to execute the application created at the developer system, request the content from the server device using the object, and present the content to a user.

26. The system of claim 25, wherein the developer system includes a software development kit that is used in creating the application, the software development kit including the object and conforming with the program development platform.
